(19) United States
(12) Patent Application Publication
(10) Pub. No.: US 2016/0214812 A1
(43) Pub. Date: Jul. 28, 2016

(54) End of Arm Tool for Grasping

(71) Applicant: R.A. Pearson Company, Spokane, WA (US)

(72) Inventor: Michael J. Johnson, Spokane, WA (US)

(21) Appl. No.: 14/604,650

(22) Filed: Jan. 23, 2015

(51) Int. Cl. B65H 3/08; B25J 15/06

(52) U.S. Cl. CPC B65H 3/0816; B25J 15/0616; B65H 3/0883; Y10S 901/40

(57) ABSTRACT

The structure and use of a grasping device, such as for use as an end-of-arm tool, are described herein. In one example, the grasping device includes a frame supporting a suction cup and a pressure cup. The suction cup and the pressure cup are attached to air pressure supplies that are below atmospheric pressure and above atmospheric pressure, respectively. In operation, the suction cup is able to grasp lightweight objects, while air exhausted by the pressure cup prevents multiple lightweight objects from becoming attached to the grasping device.

### BACKGROUND

Slip sheets may be used between layers of items (e.g., commercial products) that are placed on a pallet or packed into cases. The items may include bottles, cans, bags, plastic containers, etc. The cases may include cardboard boxes or other shipping containers. The slip sheets may be made of heavy paper, light cardboard, or similar porous materials. Robotic arms or other machinery may be used to alternately load a layer of product into a case and place a slip sheet over the loaded layer.

The process of placing the slip sheet on the loaded layer of product may be performed by mechanisms such as a gantry or a robotic arm with an end-of-arm tool that includes a suction cup. In operation, the suction cup grasps the top slip sheet from a cassette or pallet containing slip sheets and releases that slip sheet on top of the loaded layer of product. However, the porous nature of the slip sheet may allow air to be sucked through the slip sheet, thereby attracting one or more additional slip sheets, which stick to the bottom of the top slip sheet. In practice, several slip sheets routinely attach to the bottom of the top slip sheet.

In order to grasp only a single slip sheet, several techniques may be employed. In one technique, the suction may be reduced on the suction cup, such as by using a reservoir of air that is closer to ambient air pressure. However, the suction air pressure required to reliably grasp and firmly hold a single slip sheet will also attract and hold additional slip sheets that stick to the bottom of the top slip sheet. In an alternative or additional technique, brushes may be used on the edges of the slip sheets, in an attempt to disengage slip sheets that are attached to the top slip sheet by suction. However, even combined, these techniques do not solve the problem.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is an isometric view of a first example grasping device, which may be utilized as a robotic end-of-arm tool or with other machinery.

FIG. 2 is an orthographic view of the first example grasping device.

FIG. 3 is a cross-sectional view of the first example grasping device.

FIG. 4 is a cross-sectional view of the first example grasping device in operation, lifting a slip sheet that is attached to a suction cup.

FIG. 5 is an isometric view of a second example tool for uses including grasping, moving and releasing objects.

FIG. 6 is an orthographic view of the second example tool.

FIG. 7 is a cross-sectional view of the second example tool.

FIG. 8 is a second cross-sectional view of the second example tool.

FIG. 9 is an isometric view of a third example end-of-arm tool, configured for uses including general-propose object-grasping and moving, such as moving product and packaging.

FIG. 10 is an orthographic view of the third example end-of-arm tool.

FIG. 11 is a cross-sectional view of the third example end-of-arm tool.

FIG. 12 is a second cross-sectional view of the third example end-of-arm tool.

FIG. 13 is an isometric view of a fourth example tool for uses with robotic arms and other machinery.

FIG. 14 is an orthographic view of the fourth example tool.

FIG. 15 is a cross-sectional view of the fourth example tool.

FIG. 16 is a second cross-sectional view of the fourth example tool.

FIG. 17 is a cross-sectional view of a fifth example tool for uses including object grasping, moving and releasing, and use as an end-of-arm attachment.

FIG. 18 is a cross-sectional view of a sixth example tool for uses with robotic arms and other machinery.

### DETAILED DESCRIPTION

### Overview

Techniques for constructing and operating a grasping device, such as for use as an end-of-arm tool, are described herein. A number of differently-constructed example grasping devices are shown and described, each of which may utilize some or all of the underlying techniques and innovations described herein. In one example, a grasping device includes a frame supporting a suction cup and a pressure cup. The suction cup and the pressure cup are attached to air pressure supplies that are below atmospheric pressure and above atmospheric pressure, respectively. In operation, the suction cup is able to grasp lightweight objects, while air exhausted by the pressure cup prevents multiple lightweight objects from becoming attached to the grasping device. In a particular example, air may be pulled through certain areas of a porous object, such a slip sheet, by a suction cup. At the same time, air exhausted by a pressure cup may pass through other areas of the slip sheet. This air may tend to separate the slip sheet from one or more other slip sheets, thereby preventing more than one slip sheet from attaching to the grasping device.

### Example Apparatus and Techniques

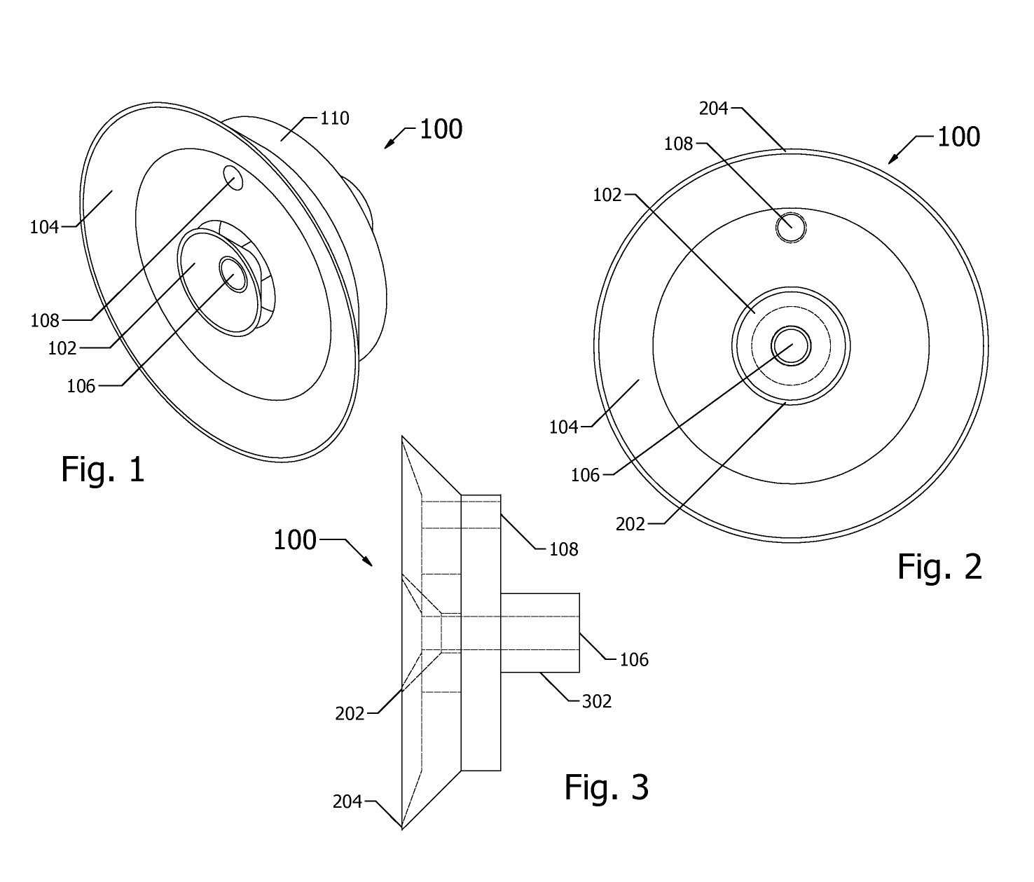

FIG. 1 is an isometric view of a first example grasping device 100, which may be utilized for purposes such as an end-of-arm tool in robotic machine applications. In this example, a suction cup 102 may be connected to a low-pressure (i.e., below ambient air pressure) air reservoir, which allows the suction cup to attach to, or connect with, an item to be grasped and released. The suction cup 102 may be nested within the pressure cup 104. The pressure cup 104 may be connected to a high-pressure (i.e., at least slightly above atmospheric pressure) air reservoir. In the example of FIG. 1, the circular suction cup 102 is nested within the circular pressure cup 104 in a concentric arrangement. However, a different nested relationships may be utilized, which may not be concentric and/or may not utilize a circular suction cup and/or a circular pressure cup. In a first example, one or more suction cups may be nested within one or more pressure cups. In a second example, one or more pressure cups may be nested within one or more suction cups. In a third example, one or more suction cups may be located adjacent to one or more pressure cups.

The suction cup 102 may be in communication with a port 106, which is connected to a low pressure air supply. In one example, the low pressure air supply may be a reservoir of air at a pressure below ambient air pressure. The pressure of a low pressure reservoir may be selected and maintained based on the application to which the grasping device 100 is used. In particular, a lower pressure may be required if the grasping device is used to attach to heavier objects. In contrast, lighter objects may be grasped by pressure that is closer to an ambient atmospheric pressure. The port 106 may be controlled by a controller circuit and a valve to allow pickup and release of an object.

The pressure cup 104 may be in communication with a port 108, which is connected to a high pressure air supply. In one example, the high pressure air supply may be a reservoir of air at a pressure above ambient air pressure. In many applications, the high pressure reservoir is incrementally (e.g., 0.5 to 5 psi) above the ambient and/or atmospheric air pressure. However, the pressure used may be based on the application to which the pressure cup is put. Accordingly, the suction cup and the pressure cup are attached to air pressure supplies that are below atmospheric pressure and above atmospheric pressure, respectively. The port 108 may be controlled by a controller circuit and a valve to allow pickup and release of an object. Accordingly, the ports 106, 108 are examples of air ports and/or air pressure supplies that are below atmospheric pressure and above atmospheric pressure, respectively.

One or both of suction cup 102 and the pressure cup 104 may be made of a resiliently deformable material, such as rubber, plastic or other materials. Alternatively, one or both of the suction cup 102 and the pressure cup 104 may be made of rigid materials, such as plastic or metal. The application to which the grasping device 100 is put may determine the material best suited for use in making the suction cup and the pressure cup, and the air pressures that are the most effective.

A frame 110 may support one or both of the suction cup 102 and the pressure cup 104. The frame 110 may be part of the grasping device or tool 100, or may be part of a robotic arm, or other product- and/or packaging-handing device.

FIG. 2 is an orthographic view of the first example grasping device 100. The vacuum cup 102 is nested within the pressure cup 104 in a concentric arrangement. In the example of FIG. 2, the area defined within the vacuum cup 102 is considerably smaller than the area of the pressure cup 104. In an alternative construction, the area of the vacuum cup and the pressure cup may be substantially equal. In a still further alternative, the area of the vacuum cup may be greater than the area of the pressure cup.

The suction cup 102 has a rim 202 and the pressure cup 104 has a rim 204. In the example shown, the rims 202, 204 are circular. However, in some applications, a differently shaped suction cup and/or pressure cup may indicate the need for differently shaped rims. In particular, if product and/or packaging having a particular shape or size is to be moved, a corresponding particular shape or size of the suction/pressure cup(s) and rim(s) may be indicated.

FIG. 3 is a cross-sectional view of the first example grasping device 100. In the example shown, the rim 202 of the suction cup 102 and the rim 204 of the pressure cup 104 are in a single plane, i.e., a rim of the suction cup and a rim of the pressure cup are in a coplanar configuration. Because the rims 202, 204 in the same plane, they may simultaneously contact an object to be grasped in response to movement of the grasping device 100. Example designs of the grasping device 100 may include rims 202, 204 that are located on parallel (not coplanar) planes. The planes may be parallel, before, during or after deformation of one or more of the suction cup(s) and/or pressure cup(s). Other design examples may be configured so that a rim of the suction cup and a rim of the pressure cup are located on parallel planes before, after or during deformation of the suction cup upon contact with an object. Such design examples may be accompanied by variations in the size, flexibility, resilience, etc., of the materials used in construction of one or both of the cups 102, 104, or by changes in other design characteristics.

An attachment site or point 302 is configured to allow attachment of the grasping device or tool 100 to a robotic arm or other machinery, thereby configuring the grasping device as an end-of-arm tool or as part of the machinery. Alternatively, the frame 110 may be attached to a robotic arm or other machinery. In a further alternative, the attachment point 302 may be part of, or combined with, the frame 100. Accordingly, the grasping device or tool 100 may be attached to a robotic arm or other machinery as desired.

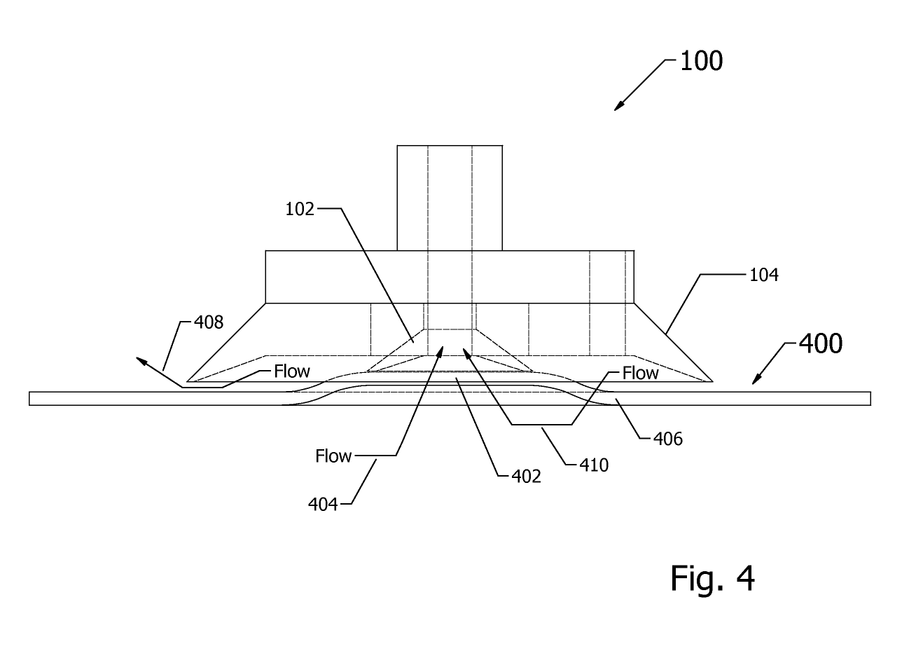

FIG. 4 shows an example grasping device or tool 100 in operation, grasping a slip sheet 400 that held in place by the suction cup 102. An area 402 of the slip sheet 400 is attached to the suction cup 102. If the slip sheet 400 is constructed of a porous material, airflow 404 will be drawn through the slip sheet and into the suction cup 102. An area 406 of the slip sheet 400 is adjacent to the pressure cup 104. However, due to airflow 408 exhausted from the pressure cup 104, the portion 406 of the slip sheet 400 is separated from the pressure cup. Airflow 408 exhausted by the pressure cup 104 may be released into the atmosphere. Additionally, airflow 410 exhausted by the pressure cup 104 may pass through the slip sheet 400, and may be pulled back through the slip sheet and into the suction cup 102. At least in part because of airflows 408, 410, a second slip sheet (not shown) will not become attached to the tool 100. Accordingly, the tool 100 will grasp only a single slip sheet, and an additional slip sheet(s) will not be grasped. Thus, a difference in pressure between air at a pressure below atmospheric pressure and attached to suction cup(s), and air at the pressure above atmospheric pressure and attached to pressure cup(s), may be great enough to move air from the pressure cup(s), through a slip sheet, and into the vacuum cup(s).

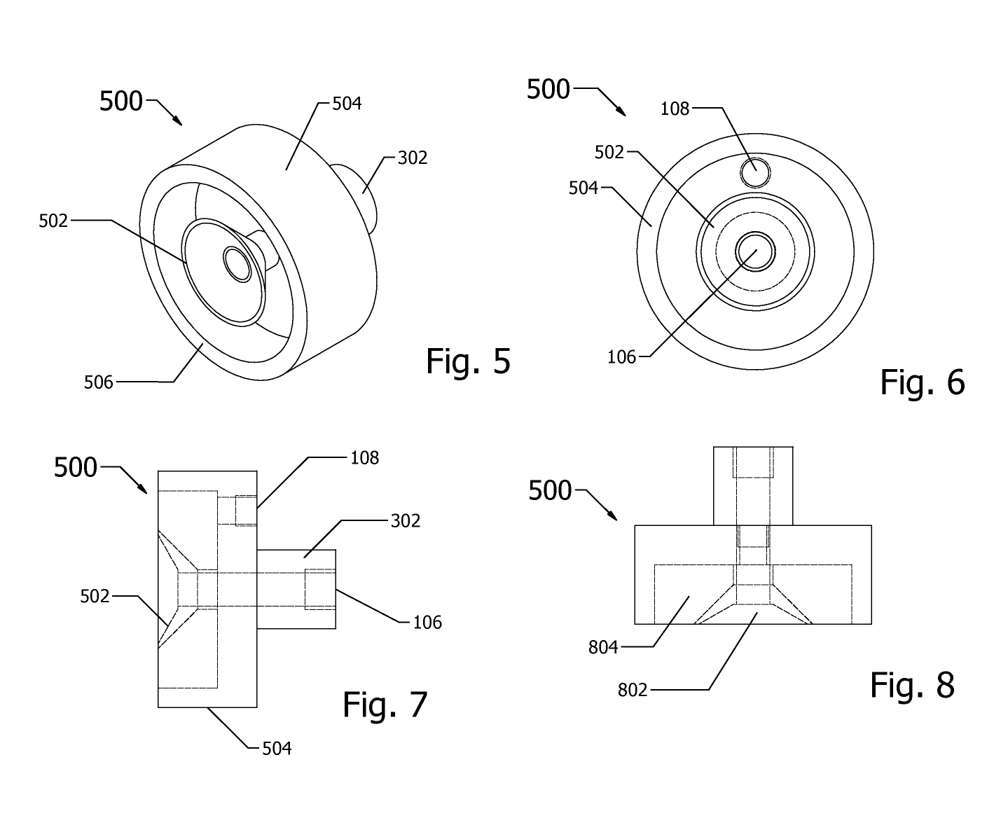

FIG. 5 shows a second example tool 500 for uses including grasping, moving and releasing objects. The objects may include product, packaging, slip sheets and/or other materials. In the tool 500, a suction cup 502 is nested within a pressure cup 504 having rigid walls. The tool 500 may include an attachment point 302 to allow connection to a robotic arm or other machinery. In operation, an object, such as a slip sheet, may attach to the suction cup 502. This may slightly deform the slip sheet, as part of the slip sheet is held in contact with the suction cup 502 and other portions of the slip sheet come into contact with a rim 506 of the pressure cup 504. As described with respect to the example tool of FIG. 4, airflow moving from the pressure cup 504 may move through pours defined in a slip sheet, and may prevent more than one slip sheet from attaching to the suction cup 502.

FIG. 6 shows the tool 500, including suction cup 502 and low pressure port 106. Pressure cup 504 is connected to a port 108 in communication with a high pressure reservoir of air (e.g., 0.5-5 psi over atmospheric pressure). The suction cup 502 and pressure cup 504 are shown in nested and concentric relationships. However, non-nested and/or non-concentric relationships could be utilized. Additionally, while the suction cup 102 and pressure cup 504 are show in a round configuration, other shapes, sizes and relative sizes could be constructed and utilized.

FIG. 7 shows the example tool 500 in a cross-sectional view, showing the ports 106 and 108 defined through the tube 302 and the rigid pressure cup 504, respectively. Tube 302 may be used as an attachment site when connecting the tool 500 to a robotic arm or other machinery. The rigid pressure cup 504 may provide the functionality of the base or frame 110, seen in FIG. 1.

FIG. 8 shows a further cross-sectional view of the tool 500. Regions of lower-than-atmospheric-pressure 802, and higher-than-atmospheric-pressure 804, are shown.

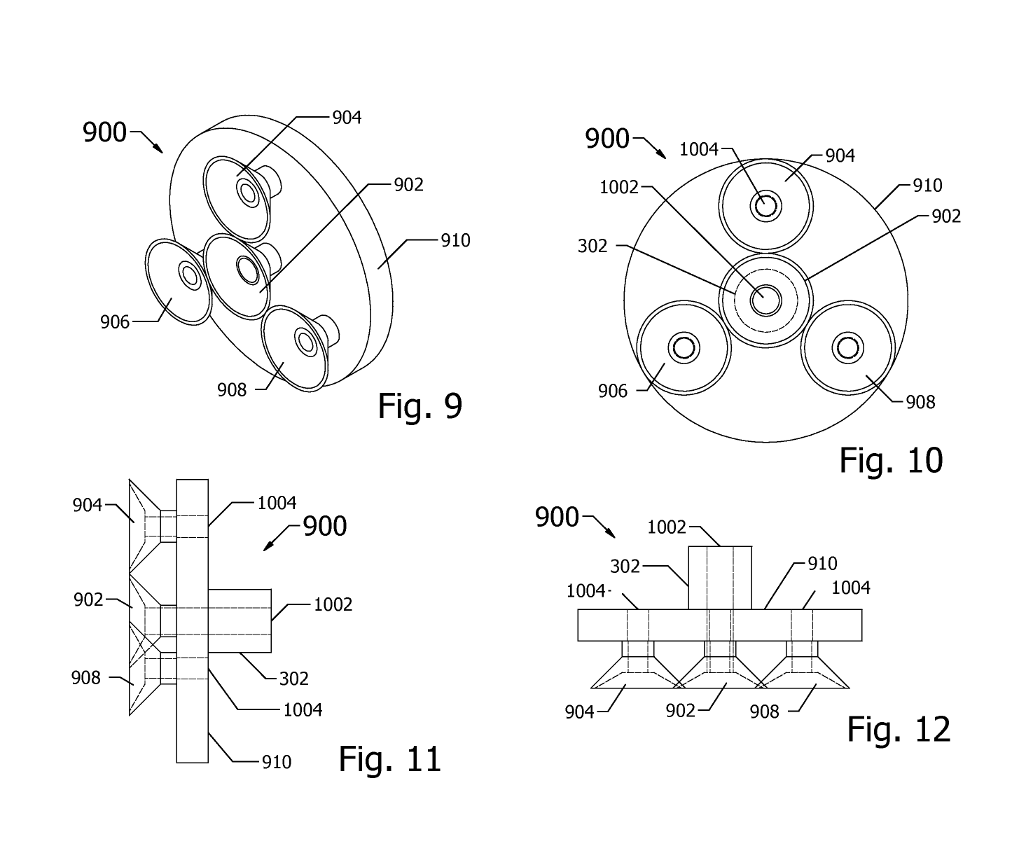

FIG. 9 shows a third example tool 900 suitable for end-of-arm use with a robotic arm or other machinery. In operation, the tool 900 may be used for various purposes, including general propose object-grasping and moving, such as moving product, packaging, slip sheets and/or other objects. At least one suction cup 902 and plurality of pressure cups 904, 906, 908 are supported by the base 910. Accordingly, the pressure cups 904-908 are located in positions adjacent to the suction cup 902, and each pressure cup is one of a plurality of pressure cups adjacent to the suction cup. The suction cup(s) and/or the pressure cup(s) may be arranged and utilized in numbers, sizes, relative sizes, and locations with respect to each other, as indicated by particular uses and/or design requirements.

In operation, the end-of-arm tool 900 may be used as a grasping device, and the frame may be utilized as a site for attachment to a robotic arm or other machinery. Differences in air pressure allow the suction cup 902, which defines an internal low air pressure region, allow attachment to a first object, such as a slip sheet, carton, product, etc. Airflow exhausted from the pressure cup(s) 904-908 prevents additional objects from becoming attached to the first object. In some applications, airflow exhausted from the pressure cup(s) moves through a porous first slip sheet, and prevents additional slip sheets from attaching to the first slip sheet. In the same or different applications, the suction cup 902 and/or the pressure cup(s) 904-908 may be flexible and deform upon contact with, and attachment to, an object.

FIG. 10 shows an orthographic view of the tool 900, including the base or frame 910, the centrally located suction cup 902 and the plurality of pressure cups 904-908. A low-pressure or vacuum port 1002 may pass through the interior of tube 302 and withdraw air from the suction cup 902. A plurality of high-pressure ports 1004 (i.e., ports providing air flow typically slightly above atmospheric pressure) may provide airflow to the plurality of pressure cups 904-908. Accordingly, ports may be connected to the suction cup and pressure cup, and may provide air pressures that are below atmospheric pressure and above atmospheric pressure, respectively. The tool 900 may be attached to a robotic arm or other machinery at the base 910, tube 302 (better seen in FIG. 11) or other location.

FIG. 11 shows a further view of the third example tool 900. The base or frame 910 supports the suction cup 902 and pressure cups 904, 908. A vacuum port 1002 is defined within the tube 302 and removes air from the suction cup 902. A pressure port 1004 is provided for each pressure cup, to deliver air at above ambient atmospheric pressure. The base 910 and/or the tube 302 may be used to attach the tool 900 to a robotic arm or other machinery. FIG. 12 shows a still further view of the third example end-of-arm tool.

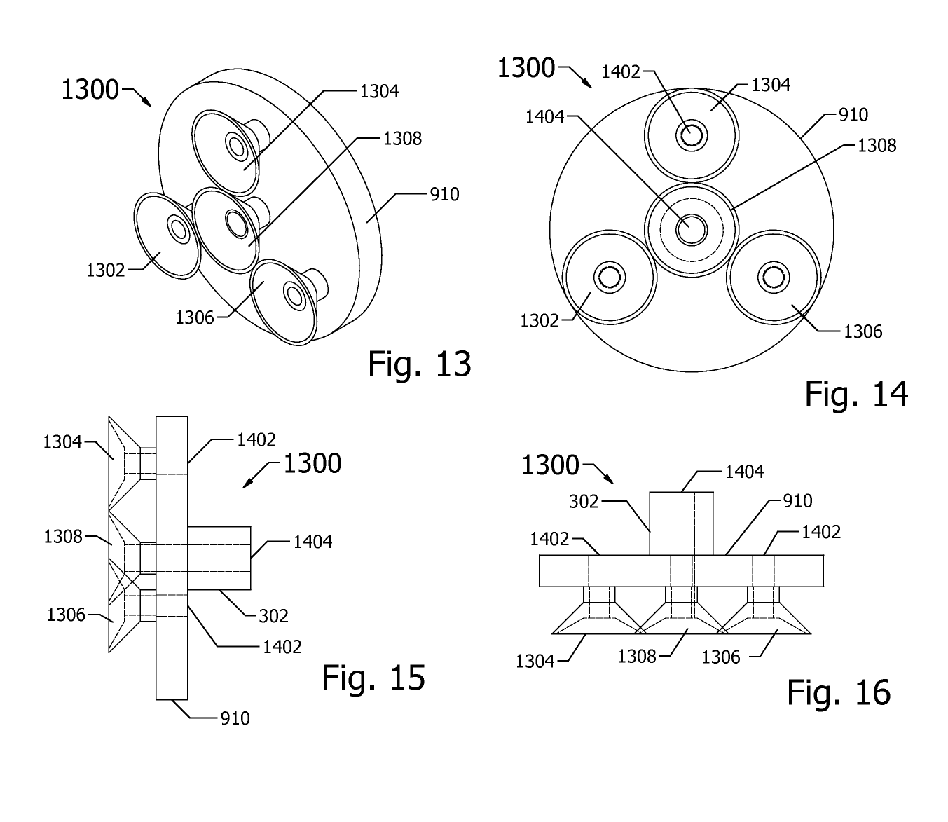

FIG. 13 is an isometric view of a fourth example tool 1300 for uses including end of arm attachment. A base 910 may support a plurality of suction cups 1302-1306 and a centrally located pressure cup 1308. FIG. 14 shows the tool 1300 an example with a single high pressure cup 1308 and three low pressure cups 1302-1306; however, a larger or smaller number of each type of cup could be included. Air may be removed from suction or partial vacuum cups 1302-1306 through a port 1402 in communication with each cup. Air at a pressure at least slightly greater than atmospheric pressure may be provided to pressure cup 1308 through port 1404. FIG. 15 shows the tool 1300 in a side cross-sectional view, including a plurality of vacuum ports 1402 (i.e., low pressure ports) in communication with vacuum or suction cups 1304, 1306. A centrally located high pressure port 1404 is in communication with the centrally located pressure cup 1308, and provides air that is at least slightly higher than atmospheric pressure. FIG. 16 shows an alternative angle of the example tool 1300.

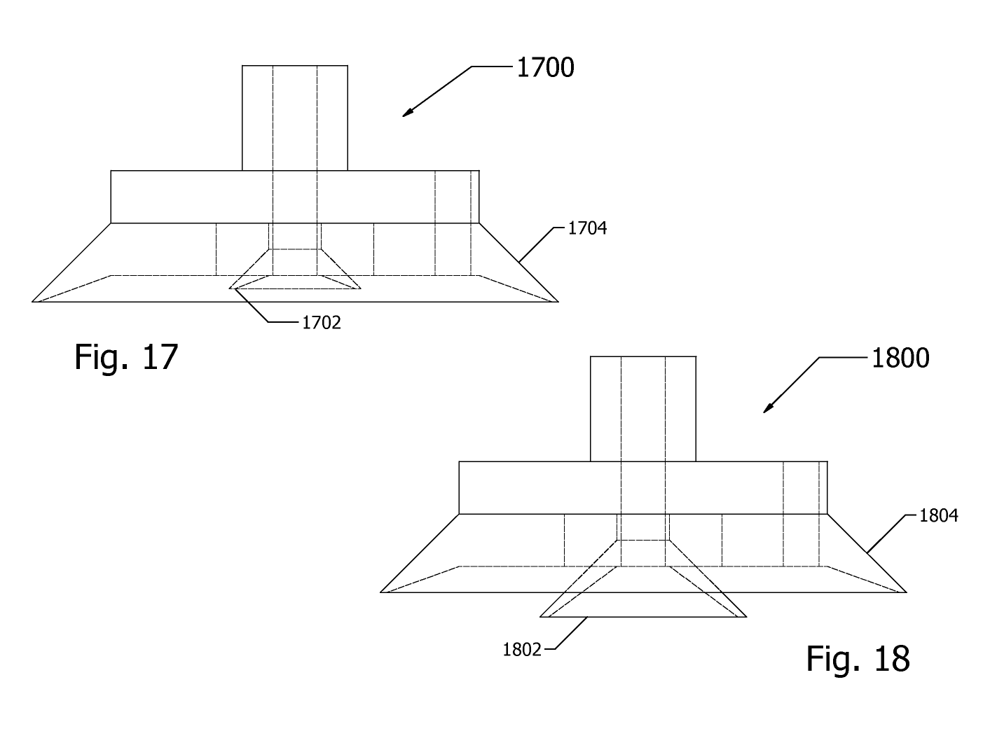

FIG. 17 shows a fifth example tool for use with a robotic arm or other machinery. In the example tool 1700, a rim or lip of the suction cup 1702 is recessed slightly to a position within the pressure cup 1704. Accordingly, the rim of the suction cup and the rim of the pressure cup are configured on parallel planes before deformation of the suction cup upon contact with an object. FIG. 18 shows a sixth example tool 1800 for use with a robotic arm or other machinery. In the example tool 1800, a rim of the suction cup 1802 extends slightly beyond a rim the pressure cup 1804. Accordingly, the rim of the suction cup and the rim of the pressure cup are configured on parallel planes before deformation of the suction cup upon contact with an object.

### CONCLUSION

Although the subject matter has been described in language specific to structural features and/or methodological acts, it is to be understood that the subject matter defined in the appended claims is not necessarily limited to the specific features or acts described. For example, while suction cups and pressure cups have been discussed as examples, more general suction devices and/or pressure devices may be used. Such suction devices and pressure devices may not include a cup-like structure, but may include foam structures, web structures, and/or other structures that are configured to grasp and release items using air pressure and/or partial vacuum. Moreover, while suction cups, vacuum cups and low pressure cups have been discussed, such terminology refers to similar cups in communication with air below atmospheric pressure. Accordingly, the specific features and acts are disclosed as exemplary forms of implementing the claims

1. A grasping device, comprising:
a frame;
a suction cup, supported by the frame; and
a pressure cup, supported by the frame, wherein the suction cup and the pressure cup are attached to air pressure supplies that are below atmospheric pressure and above atmospheric pressure, respectively.

2. The grasping device as recited in claim 1, wherein a rim of the suction cup and a rim of the pressure cup are in a coplanar configuration.

3. The grasping device as recited in claim 1, wherein the suction cup and the pressure cup are nested.

4. The grasping device as recited in claim 1, wherein the pressure cup is one of a plurality of pressure cups adjacent to the suction cup.

5. The grasping device as recited in claim 1, wherein the grasping device is an end-of-arm tool, and wherein the frame comprises a site for attachment to an arm.

6. The grasping device as recited in claim 1, wherein at least one of the suction cup and the pressure cup are flexible and deform upon contact with, and attachment to, an object.

7. (canceled)

8. An end-of-arm tool, comprising:
a suction cup having a port connected to air at a pressure below atmospheric pressure;
a pressure cup having a port connected to air at a pressure above atmospheric pressure, wherein the suction cup is nested within the pressure cup; and
a frame, to which the suction cup and the pressure cup are attached, providing an end-of-arm attachment point.

9. The end-of-arm tool as recited in claim 8, wherein a rim of the suction cup and a rim of the pressure cup are in a coplanar configuration.

10. The end-of-arm tool as recited in claim 8, wherein a rim of the suction cup and a rim of the pressure cup are configured on parallel planes after deformation of the suction cup upon contact with an object.

11. The end-of-arm tool as recited in claim 8, wherein the suction cup is deformable and wherein a rim of the suction cup is out of a plane defined by a rim of the pressure cup either prior to, during, or after, deformation.

12. The end-of-arm tool as recited in claim 8, wherein the suction cup and the pressure cup are in a concentric nested relationship.

13. The end-of-arm tool as recited in claim 8, wherein a difference between the pressure below atmospheric pressure and the air at the pressure above atmospheric pressure is great enough to move air from the pressure cup, through a slip sheet, and into the suction cup.

14. The end-of-arm tool as recited in claim 8, wherein:
one of the suction cup and the pressure cup are resiliently deformable; and
one of the suction cup and the pressure cup are rigid.

15. A tool, comprising:
a suction cup connected to air at a pressure below atmospheric pressure;
a pressure cup connected to air at a pressure above atmospheric pressure, wherein the suction cup is nested within the pressure cup; and
a frame, to which the suction cup and the pressure cup are attached, providing an attachment point.

16. The tool as recited in claim 15, wherein the suction cup is resiliently deformable and is coplanar with the pressure cup before or during contact with an object.

17. The tool as recited in claim 15, wherein the suction cup is nested within the pressure cup in a concentric manner.

18. The tool as recited in claim 15, wherein the pressure cup has an area that is larger than the suction cup.

19. The tool as recited in claim 15, wherein a difference between the pressure below atmospheric pressure and the pressure above atmospheric pressure is great enough to move air from the pressure cup, through a slip sheet, and into the suction cup.

20. The tool as recited in claim 15, wherein at least one of the suction cup and the pressure cup is resiliently deformable.
